(19) United States
(12) Patent Application Publication
(10) Pub. No.: US 2023/0217159 A1
(43) Pub. Date: Jul. 6, 2023

(54) ACCESS-FEATURE-MOUNTED EXTERNAL SPEAKER

(71) Applicant: Apple Inc., Cupertino, CA (US)

(72) Inventors: Daniel K. BOOTHE, San Francisco, CA (US); Onur I. ILKORUR, Santa Clara, CA (US); Marty E. JOHNSON, Los Gatos, CA (US); Chris WILK, Los Gatos, CA (US); Jason T. PARKER, San Francisco, CA (US)

(21) Appl. No.: 17/966,758

(22) Filed: Oct. 14, 2022

Related U.S. Application Data
(60) Provisional application No. 63/296,835, filed on Jan. 5, 2022.

(51) Int. Cl. H04R 1/34; H04R 1/02; H04R 3/00; B60J 5/04

(52) U.S. Cl. CPC H04R 1/345; B60J 5/0413; H04R 1/025; H04R 3/00; B60J 1/12; H04R 2499/13

(57) ABSTRACT

Implementations of the subject technology provide a access-feature-mounted external speaker. The access-feature-mounted external speaker may be disposed within an internal cavity in the door, and acoustically coupled to a slot in an edge of the door by an acoustic duct. In a closed position of the door, sound from the access-feature-mounted external speaker may be projected into a gap between the door and a structural interface of an enclosure, and redirected in part by the structural interface to a location external to the enclosure. In an open position of the door, sound from the speaker may be projected into an opening in the enclosure.

### CROSS REFERENCE TO RELATED APPLICATIONS

This application claims the benefit of priority to U.S. Provisional Pat. Application No. 63/296,835, entitled, “Access-Feature-Mounted External Speaker”, filed on Jan. 5, 2022, the disclosure of which is hereby incorporated herein in its entirety.

### TECHNICAL FIELD

The present description relates generally to acoustic devices, including, for example, access-feature-mounted external speakers.

### BACKGROUND

Acoustic devices can include speakers that generate sound and microphones that detect sound. Acoustic devices are often deployed in enclosed spaces, such as conference rooms, to provide audio output to the population of occupants in the enclosed space.

### BRIEF DESCRIPTION OF THE DRAWINGS

Certain features of the subject technology are set forth in the appended claims. However, for purpose of explanation, several embodiments of the subject technology are set forth in the following figures.

FIGS. 1 and 2 illustrate aspects of an example apparatus in accordance with one or more implementations.

FIG. 3 illustrates a top view of an example apparatus having an enclosed space and a speaker mounted in an access feature and acoustically coupled to a slot in an edge of the access feature, in accordance with implementations of the subject technology.

FIG. 4 illustrates a side view of the access feature of FIG. 3 in which the edge of the access feature is visible, in accordance with implementations of the subject technology.

FIG. 5 illustrates a perspective view of a lower portion of the access feature of FIG. 4, in accordance with implementations of the subject technology.

FIG. 6 illustrates a top view of a portion of the apparatus of FIG. 3 in the vicinity of an interface between the access feature of FIG. 4 and a structural interface that defines a portion of an opening in the enclosure of the apparatus, with the access feature in a closed position, in accordance with implementations of the subject technology.

FIG. 7 illustrates a top view of the portion of the apparatus of FIG. 6 in which the access feature of FIG. 6 is in an open position, in accordance with implementations of the subject technology.

FIG. 8 illustrates a top view of a portion of the apparatus of FIG. 3 in the vicinity of an interface between an access feature and a structural interface that defines a portion of an opening in the enclosure of the apparatus and has a sealing member, with the access feature in an open position, in accordance with implementations of the subject technology.

FIG. 9 illustrates a top view of the portion of the apparatus of FIG. 8, with the access feature in a closed position, in accordance with implementations of the subject technology.

FIG. 10 illustrates a perspective view of a lower portion of an access feature having a slot that includes an edge portion and an outer portion, in accordance with implementations of the subject technology.

FIG. 11 illustrates a top view of a portion of the apparatus of FIG. 3 in the vicinity of an interface between the access feature of FIG. 10 and a structural interface that defines a portion of an opening in the enclosure of the apparatus and has a sealing member, with the access feature in an open position, in accordance with implementations of the subject technology.

FIG. 12 illustrates a top view of the portion of the apparatus of FIG. 11 with the access feature in a closed position, in accordance with implementations of the subject technology.

FIG. 13 illustrates a flow chart of example operations that may be performed for operating an access-feature-mounted external speaker in accordance with implementations of the subject technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Acoustic devices, such as speakers, can be deployed at various locations within an enclosure that defines an enclosed space, for providing audio output to an occupant (sometimes referred to herein as a user) within the enclosed space. In some circumstances, it may also be desirable to be able to provide audio output to a location external to the enclosure. For example, when a train, a bus, or another vehicle, such as an autonomous or semiautonomous vehicle, comes to a stop, it may be desirable to provide a notification to a person or multiple people outside the vehicle. As an example, it may be desirable to provide a notification of a route or a destination of the vehicle, or to announce a name of a person being picked up by the vehicle.

In one or more implementations, an externally facing speaker may be mounted in a door of the enclosure. However, access features such as doors often also house mechanical and/or electrical equipment (e.g., equipment for opening, closing, locking, and/or unlocking the door, and/or equipment for opening and or closing a window mounted to the door). In some examples a window may be configured to be retractable into an interior cavity of the door, and space for the retracted window may be maintained within the interior cavity and unavailable for other components, such as a speaker. One option is to mount a speaker within the door below the mechanical and/or electrical equipment and/or the window region of the door. However, mounting a speaker at such as low position in the door can cause confusion, and/or an undesirable experience for a person outside the apparatus an receiving a notification from the speaker. For example, the person may mistake the origin of the notification as being beneath the vehicle. For these reasons, it can be challenging to incorporate an external speaker (e.g., a speaker configured to emit sound externally) in a door of an apparatus, such as a vehicle.

Moreover, in some uses cases, it may be desirable to be able to provide a timely notification to a person entering and/or exiting the vehicle through an opening in the enclosure, when the door is in an open configuration. However, a speaker that is directed to an interior of the enclosure, or a speaker that is directed to an exterior of the enclosure, may be directed away from the opening in the enclosure when the door is in the open configuration.

Implementations of the subject technology described herein provide access-feature-mounted external speakers that may address some or all of the above challenges. In one or more implementations, a door to an apparatus, such as a vehicle, may be provided with a speaker that is acoustically coupled to a slot that is at least partially formed in an edge of the door. In this way, when the door is in a closed configuration, sound may be projected from the slot in the edge of the door and redirected by a seal between the door and the enclosure to a location external to the enclosure. When the door is in an open configuration, the sound may be projected from the slot in the edge of the door into the opening in the enclosure through which an occupant enters and/or exits the enclosure. In one or more implementations, an access-feature-mounted external speaker, such as a door-mounted external speaker, may be arranged to project sound in different directions depending on the open or closed configuration of the access feature.

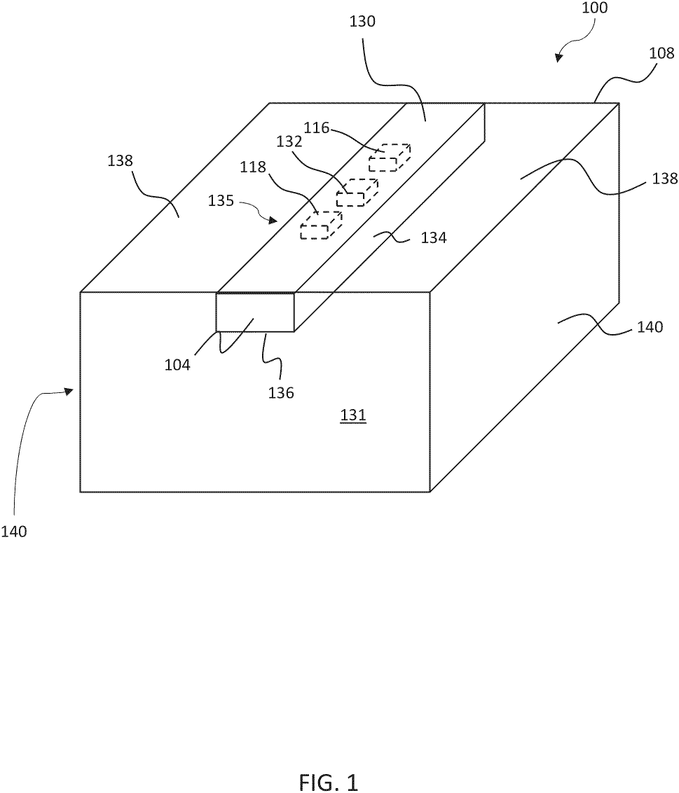

An illustrative apparatus including one or more speakers and/or one or more access features, such as doors, is shown in FIG. 1. In the example of FIG. 1, an apparatus 100 includes an enclosure 108 and a structural support member 104. The enclosure may (e.g., at least partially) define an enclosed environment 131. In the example of FIG. 1, the enclosure 108 includes top housing structures 138 mounted to and extending from opposing sides of the structural support member 104, and a sidewall housing structure 140 extending from each top housing structure 138.

In this example, the enclosure 108 is depicted as a rectangular enclosure in which the sidewall housing structures 140 are attached at an angle to a corresponding top housing structure 138. However, it is also appreciated that this arrangement is merely illustrative, and other arrangements are contemplated. For example, in one or more implementations, the top housing structure 138 and the sidewall housing structure 140 on one side of the structural support member 104 may be formed from a single (e.g., monolithic) structure having a bend or a curve between a top portion (e.g., corresponding to a top housing structure 138) and a side portion (e.g., corresponding to a sidewall housing structure 140). For example, in one or more implementations, the top housing structure 138 and the sidewall housing structure 140 on each side of the structural support member 104 may be formed from a curved glass structure. In this and/or other implementations, the sidewall housing structure 140 and/or other portions of the enclosure 108 may be or include a reflective surface (e.g., an acoustically reflective surface).

As illustrated in FIG. 1, the apparatus 100 may include various components such as one or more safety components 116, one or more speakers 118, and/or one or more other components 132. In the example of FIG. 1, the safety component 116, the speaker 118, and the other component 132 are mounted in a structural space 130 at least partially within the structural support member 104. The other component 132 may include, as examples, one or more displays, microphones, or more cameras, and/or one or more sensors. The cameras and/or sensors may be used to identify an occupant within the enclosed environment 131 or at, near, or within an entrance or exit to the enclosure 108, such as an entrance or exit formed by an opening in the enclosure 108. In one or more implementations, an opening in the enclosure may be selectively opened and closed by an access feature, such as a door. It is also contemplated that one or more safety components 116, one or more speakers 118, and/or one or more other components 132 may also, and/or alternatively, be mounted to the enclosure 108, and/or to and/or within one or more other structures of the apparatus 100. As shown in FIG. 1, the structural support member 104 may include a first side 134, an opposing second side 135, and a bottom surface 136 that faces an interior of the enclosed environment 131 defined by the enclosure 108.

In various implementations, the apparatus 100 may be implemented as a stationary apparatus (e.g., a conference room or other room within a building) or a moveable apparatus (e.g., a vehicle such as a train car, an airplane, an autonomous or semiautonomous vehicle, a boat, a ship, a helicopter, etc.) that can be temporarily occupied by one or more human occupants. In one or more implementations, (although not shown in FIG. 1), the apparatus 100 may include one or more seats for one or more occupants. In one or more implementations, one or more of the seats may be mounted facing in the same direction as one or more other seats, and/or in a different (e.g., opposite) direction of one or more other seats.

In one or more implementations, the apparatus 100 may be implemented as a moveable platform such as a vehicle (e.g., an autonomous vehicle that navigates roadways using sensors and/or cameras and substantially without control by a human operator, a semiautonomous that includes human operator controls and that navigates roadways using sensors and/or cameras with the supervision of a human operator, or a vehicle with the capability of switching between a fully autonomous driving mode, a semiautonomous driving mode, and/or a human controlled mode). In various versions of such an implementation, one or more seats of the apparatus may be oriented toward the interior of the vehicle, facing out the sides of the vehicle, facing toward the front of the vehicle, facing toward the rear of the vehicle, and/or rotatable between various orientations.

In one or more use cases, it may be desirable to provide audio content to one or more occupants within the enclosed environment 131, to a person at a location external to the enclosure 108, and/or to a person within an opening (e.g., an entrance or exit) of the enclosure 108. The audio content may include general audio content intended for all of the occupants and/or personalized audio content for one or a subset of the occupants. The audio content may be generated by the apparatus 100, or received by the apparatus from an external source or from a portable electronic device within the enclosed environment 131.

In one or more implementations, it may be desirable to be able to direct the audio content, or a portion of the audio content, to one or more particular locations within the enclosed environment 131, one or more particular locations external to the enclosure 108, and/or one or more particular locations within an opening in the enclosure 108. In various examples, the speaker 118 may be mounted within an access feature, such as a door, of the apparatus 100, and may be acoustically coupled to a slot in an edge of the access feature, as discussed in further detail hereinafter.

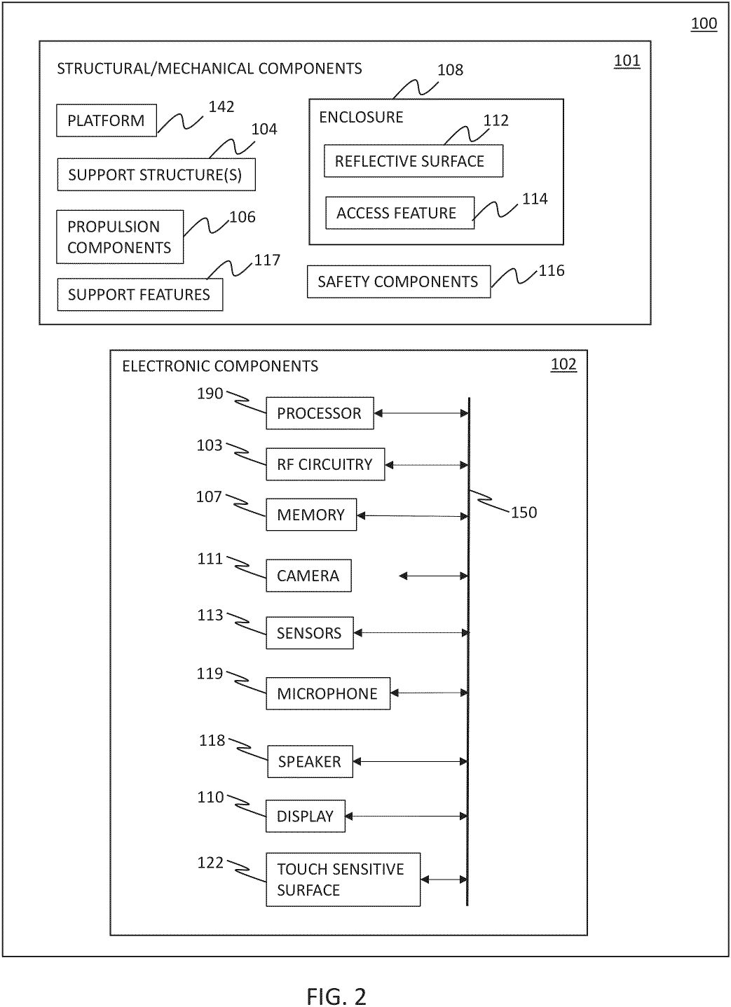

In various implementations, the apparatus 100 may include one or more other structural, mechanical, electrical, and/or computing components that are not shown in FIG. 1. For example, FIG. 2 illustrates a schematic diagram of the apparatus 100 in accordance with one or more implementations.

As shown in FIG. 2, the apparatus 100 may include structural and/or mechanical components 101 and electronic components 102. In this example, the structural and/or mechanical components 101 include the enclosure 108, the structural support member 104, and the safety component 116 of FIG. 1. In this example, the structural and/or mechanical components 101 also include a platform 142, propulsion components 106, and support features 117. In this example, the enclosure 108 includes a reflective surface 112 and an access feature 114. In one or more implementations, a reflective surface 112 may form a portion of an access feature 114 (e.g., a window may form a portion, such as an upper portion, of a door of the apparatus).

As examples, the safety components 116 may include one or more seatbelts, one or more airbags, a roll cage, one or more fire-suppression components, one or more reinforcement structures, or the like. As examples, the platform 142 may include a floor, a portion of the ground, or a chassis of a vehicle. As examples, the propulsion components may include one or more drive system components such as an engine, a motor, and/or one or more coupled wheels, gearboxes, transmissions, or the like. The propulsion components may also include one or more power sources such as fuel tank and/or a battery. As examples, the support feature 117 may be support features for occupants within the enclosed environment 131 of FIG. 1, such as one or more seats, benches, and/or one or more other features for supporting and/or interfacing with one or more occupants. As examples, the reflective surface 112 may be a portion of a top housing structure 138, a sidewall housing structure 140 of FIG. 1, or an access feature 114, such as a glass structure (e.g., a curved glass structure). As examples, the access feature 114 may be a door or other feature for selectively allowing occupants to enter and/or exit the enclosed environment 131 of FIG. 1 through an opening in the enclosure 108 that is occupied by the access feature 114 when the access feature 114 is in a closed position.

As illustrated in FIG. 2, the electronic components 102 may include various components, such as a processor 190, RF circuitry 103 (e.g., WiFi, Bluetooth, near field communications (NFC) or other RF communications circuitry), memory 107, a camera 111 (e.g., an optical wavelength camera and/or an infrared camera, which may be implemented in the other components 132 of FIG. 1), sensors 113 (e.g., an inertial sensor, such as one or more accelerometers, one or more gyroscopes, and/or one or more magnetometers, radar sensors, ranging sensor such as LIDAR sensors, depth sensors, temperature sensors, humidity sensors, etc. which may also be implemented in the other components 132 of FIG. 1), one or more microphones such as microphone 119, one or more speakers such as speaker 118, a display 110, and a touch-sensitive surface 122. These components optionally communicate over a communication bus 150. Although a single processor 190, RF circuitry 103, memory 107, camera 111, sensor 113, microphone 119, speaker 118, display 110, and touch-sensitive surface 122 are shown in FIG. 2, it is appreciated that the electronic components 102 may include one, two, three, or generally any number of processors 190, RF circuitry 103, memories 107, cameras 111, sensors 113, microphones 119, speakers 118, displays 110, and/or touch-sensitive surfaces 122.

In the example of FIG. 2, apparatus 100 includes a processor 190 and memory 107. Processor 190 may include one or more general processors, one or more graphics processors, and/or one or more digital signal processors. In some examples, memory 107 may include one or more non-transitory computer-readable storage mediums (e.g., flash memory, random access memory, volatile memory, non-volatile memory, etc.) that store computer-readable instructions configured to be executed by processor 190 to perform the techniques described below.

In one or more implementations, cameras 111 and/or sensors 113 may be used to identify an occupant within the enclosed environment 131, and/or a person at, near, or within an opening in the enclosure 108, and/or to determine the location of an occupant within the enclosed environment 131 and/or the location of the person at, near, or within an opening in the enclosure 108. For example, one or more cameras 111 may capture images of the enclosed environment 131 and/or an external location adjacent the access feature 114, and the processor 190 may use the images to determine whether a seat within the enclosed environment 131 is occupied by an occupant, whether a person is outside the enclosure and waiting to enter the enclosure via the access feature 114, and/or whether a person is within an opening in the enclosure (e.g., actively entering or exiting the enclosure). In one or more other implementations, one or more sensors 113 disposed in the access feature 114 and/or within the opening in the enclosure 108 may detect the presence of a person or people outside the access feature and/or within the opening in the enclosure.

In various implementations, the processor 190 may use the images and/or sensor signals to make a binary determination of whether a seat is occupied or unoccupied and/or whether a person is located at, near, or within the opening in the enclosure, or the processor 190 may determine whether a seat is occupied by a particular occupant and/or whether a particular person is located at, near, or within the opening in the enclosure. In one or more implementations, a particular person can be actively identified by information provided by the occupant upon entry into the enclosed environment 131 (e.g., by scanning an identity card or a mobile device acting as an identity card with a sensor 113, or by facial recognition or other identity verification using the cameras 111 and/or the sensors 113), or passively (e.g., by determining that a seat is occupied and that that seat has been previously reserved for a particular occupant during a particular time period, such as by identifying an occupant of a seat as a ticketholder for that seat, or by determining that a person external to the apparatus is at an expected pickup location for that a particular person).

Communications circuitry, such as RF circuitry 103, optionally includes circuitry for communicating with electronic devices, networks, such as the Internet, intranets, and/or a wireless network, such as cellular networks and wireless local area networks (LANs). RF circuitry 103 optionally includes circuitry for communicating using near-field communication and/or short-range communication, such as Bluetooth®. RF circuitry 103 may be operated (e.g., by processor 190) to communicate with a portable electronic device in the enclosed environment 131.

Display 110 may incorporate LEDs, OLEDs, a digital light projector, a laser scanning light source, liquid crystal on silicon, or any combination of these technologies. Examples of display 110 include head up displays, automotive windshields with the ability to display graphics, windows with the ability to display graphics, lenses with the ability to display graphics, tablets, smartphones, and desktop or laptop computers. In one or more implementations, display 110 may be operable in combination with the speaker 118. In one or more implementations, the apparatus 100 may include multiple displays, such as multiple displays each facing a respective occupant location within the enclosure 108, for outputting video content to an occupant at that respective occupant location.

Touch-sensitive surface 122 may be configured for receiving user inputs, such as tap inputs and swipe inputs. In some examples, display 110 and touch-sensitive surface 122 form a touch-sensitive display.

Camera 111 optionally includes one or more visible light image sensors, such as charged coupled device (CCD) sensors, and/or complementary metal-oxide-semiconductor (CMOS) sensors operable to obtain images within the enclosed environment 131 and/or of an environment external to the enclosure 108. Camera 111 may also optionally include one or more infrared (IR) sensor(s), such as a passive IR sensor or an active IR sensor, for detecting infrared light from within the enclosed environment 131 and/or of an environment external to the enclosure 108. For example, an active IR sensor includes an IR emitter, for emitting infrared light. Camera 111 also optionally includes one or more event camera(s) configured to capture movement of occupants within the enclosed environment 131 and/or objects such as people, vehicles, roadside objects and/or pedestrians outside the enclosure 108, or within an opening in the enclosure 108. Camera 111 also optionally includes one or more depth sensor(s) configured to detect the distance of physical elements from the enclosure 108 and/or from other objects within the enclosed environment 131. In some examples, camera 111 includes CCD sensors, event cameras, and depth sensors that are operable in combination to detect the physical setting around apparatus 100.

In some examples, sensors 113 may include radar sensor(s) configured to emit radar signals, and to receive and detect reflections of the emitted radar signals from one or more objects in the environment around the enclosure 108. Sensors 113 may also, or alternatively, include one or more scanners (e.g., a ticket scanner, a fingerprint scanner or a facial scanner), one or more depth sensors, one or more motion sensors, one or more temperature or heat sensors, or the like. In some examples, one or more microphones such as microphone 119 may be provided to detect sound from an occupant within the enclosed environment 131 and/or from one or more audio sources within the enclosure 108 and/or external to the enclosure 108. In some examples, microphone 119 includes an array of microphones that optionally operate in tandem, such as to identify ambient noise or to locate the source of sound in space.

Sensors 113 may also include positioning sensors for detecting a location of the apparatus 100, and/or inertial sensors for detecting an orientation and/or movement of apparatus 100. For example, processor 190 of the apparatus 100 may use inertial sensors and/or positioning sensors (e.g., satellite-based positioning components) to track changes in the position and/or orientation of apparatus 100, such as with respect to physical elements in the physical environment around the apparatus 100. Inertial sensor(s) of sensors 113 may include one or more gyroscopes, one or more magnetometers, and/or one or more accelerometers.

As discussed herein, one or more speakers, such as speaker 118 may be mounted in the access feature 114.

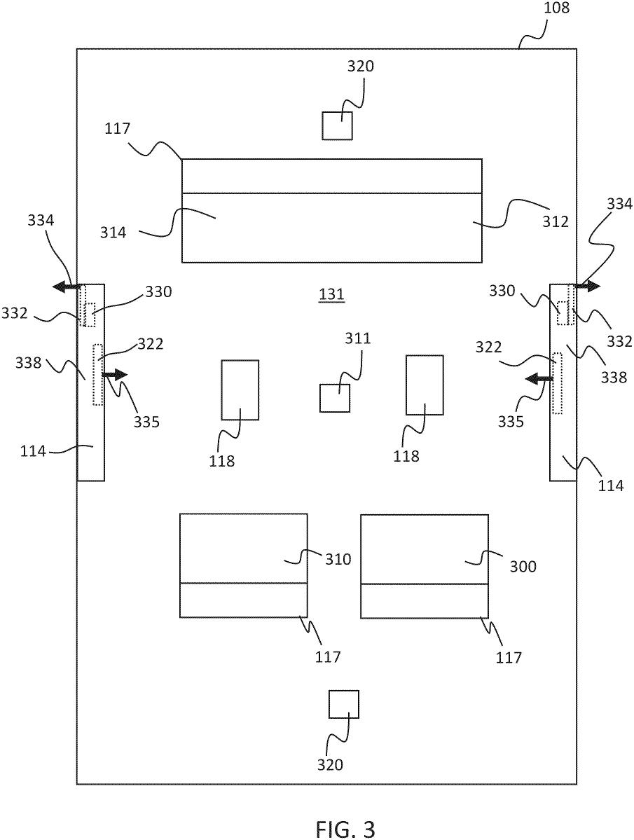

FIG. 3 illustrates a schematic top view of an example implementation of the apparatus 100 in which various speakers 118 are disposed at various locations within the apparatus 100. In the example of FIG. 3, the apparatus 100 includes the enclosure 108, and one or more seats, such as a seat 300, a seat 310, a seat 312, and a seat 314 within the enclosure 108. As indicated, the seat 300, the seat 310, the seat 312, and/or the seat 314 may each be an implementation of the support feature 117 of FIG. 2.

As shown, the access feature 114 may be implemented as a door to the apparatus 100. In the example of FIG. 3, the apparatus 100 includes two access features 114 that are each in a closed position on opposing sides of the apparatus. As illustrated in FIG. 3, a speaker 330 (e.g., an implementation of the speaker 118 of FIGS. 1 and 2) may be mounted in an interior cavity 338 of an access feature 114, such as a door to the enclosure 108. As illustrated, an acoustic duct 332 within the interior cavity 338 may acoustically couple the speaker 330 to a port at an edge of the access feature 114. As illustrated in FIG. 3, in the closed position of the access feature 114, an audio output from the speaker 330 may be redirected (e.g., by a portion of the enclosure, as described in further detail hereinafter), in a direction 334 outward of the enclosure. In this way, the speaker 330 encompassed within the interior cavity 338 of the access feature 114 may be operable to provide a notification or other audio output to a person outside the enclosure 108 and at or near the access feature 114. In this way, the apparatus 100 may be provided with an access-feature-mounted external speaker, such as a door-mounted external speaker, in one or more implementations.

In contrast with the external audio output of the speaker 330 in the direction 334, an internally directed audio output (e.g., in an inward direction 335) may also be generated by, for example, another speaker 322 mounted in to the access feature 114 (e.g., within or partially within the interior cavity 338). In various implementations, the speaker 322 may be another implementation of the speaker 118 of FIGS. 1 and 2 and/or may include multiple speakers (e.g., one or more tweeters and/or one or more mid-range speakers). In one or more implementations, the speaker 322 may be implemented as a beamforming array of speakers 118 that can be cooperated to direct audio output to various locations within the enclosure 108.

In the example of FIG. 3, the apparatus 100 includes additional speakers 118 at various locations. For example, the apparatus 100 may also include a speaker 118 disposed between the seat 300 and the seat 312, and a speaker 118 disposed between the seat 310 and the seat 314. In this example, the speaker 118 disposed between the seat 300 and the seat 312, and the speaker 118 disposed between the seat 310 and the seat 314 may be implemented as a directional speaker (e.g., a directional speaker having one or more sound-suppressing acoustic ducts, a dual-directional speaker having a pair of acoustic ducts, or an isobaric cross-firing speaker, or any other directional speaker), configured to direct audio output toward one or more particular locations within the enclosed environment 131, such as the location of one of the seats within the enclosure 108. In the example of FIG. 3, the apparatus 100 also include a center speaker 311 and one or more speaker arrays 320 (e.g., beamforming speaker arrays).

It is appreciated that one, any sub-combination, or all, of the speakers 118, 330, 322, and/or 320 shown in FIG. 3 may be implemented in the apparatus 100. It is also appreciated that additional speakers 118 may be implemented in the apparatus 100 at one or more other locations, and the locations of the speakers 118 of FIG. 3 are merely illustrative. In the example of FIG. 3, the apparatus includes four seats. However, this is merely illustrative, and, in other implementations, fewer than four, or more than four seats may be included within the enclosure 108. In the example of FIG. 3, the apparatus includes two access features 114 having speakers 330 with acoustic ducts 332 that acoustically couple the speakers 330 to edges of the access features. However, this is merely illustrative, and, in other implementations, fewer than two, or more than two access features 114 having speakers 330 with acoustic ducts 332 that acoustically couple the speakers 330 to edges of the access features may be included within the enclosure 108.

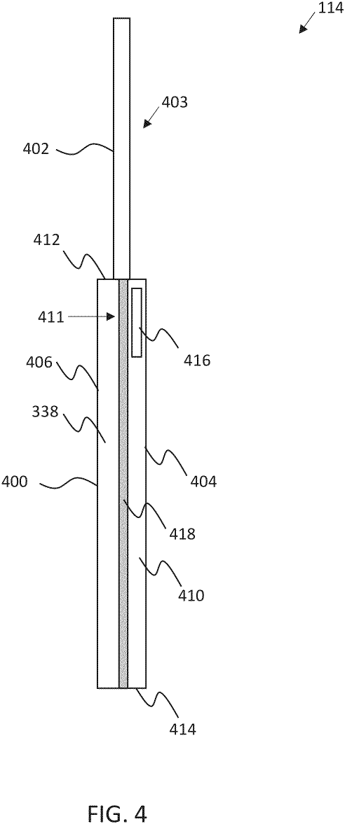

FIG. 4 illustrates a side view of the access feature 114 of FIG. 3, in which an edge 410 of the access feature 114 is visible. As shown in FIG. 4, in one or more implementations, the access feature 114 may include an exterior wall 404, an interior wall 406, and the interior cavity 338 may be defined in part by (e.g., between) the exterior wall 404 and the interior wall 406. As shown, the edge 410 may extend substantially between the exterior wall 404 and the interior wall 406 and may further define a portion (e.g., an end or a sidewall) of the interior cavity 338.

In the side view of FIG. 4, the speaker 330 disposed within the interior cavity 338 is not visible, but the slot 416 in the edge 410 is visible. The speaker 330 of FIG. 3 may be acoustically coupled to the slot 416 by the acoustic duct 332 extending from the speaker 330 to the slot 416, as discussed above in connection with FIG. 3.

As shown in FIG. 4, the access feature 114 may include a sealing member 418 that runs along the edge 410 substantially parallel to the interior wall 406 and the exterior wall 404. In one or more implementations, the sealing member 418 may be a weather seal formed from a rubber, plastic, silicone, or other resilient material that can be partially compressed between the access feature 114 and a structural interface of the enclosure 108 to fluidly seal the enclosed environment 131 within the enclosure 108 from the external environment of the enclosure 108. As shown, a portion 411 of the sealing member 418 is disposed on the edge 410 between the slot 416 and the interior wall 406. In other words, the slot 416 may be disposed on the edge 410 at a location that is external to, or outward of, the location of the sealing member 418. In this way, the slot 416 may be acoustically coupled to the external environment of the apparatus 100, even in a closed position of the access feature 114 in which the sealing member 418 fluidly seals the enclosed environment 131 (FIG. 3) from the external environment.

As shown in FIG. 4, the exterior wall 404, the interior wall 406, the edge 410, and the interior cavity 338 may form a lower portion 400 of the access feature 114. The lower portion 400 may have a top edge 412 and a bottom edge 414. As shown, the access feature 114 may also include a window 402 (e.g., an implementation of the reflective surface 112). In one or more implementations, the window 402 may be retractable into the interior cavity 338 in an open configuration of the window 402, and extendible from the top edge 412 of the lower portion 400 of the access feature 114 to form at least a part of an upper portion 403 of the access feature (e.g., in a closed configuration for the window 402, as shown in FIG. 4).

FIG. 5 illustrates as top perspective view of the lower portion 400 of the access feature 114 of FIG. 4. As shown in FIG. 5, the sealing member 418 may protrude from the edge 410. In the example of FIG. 5, the acoustic duct 332 is shown extending into the interior cavity 338 from the slot 416. As shown in FIGS. 4 and 5, the slot 416 may be located nearer the top edge 412 of the lower portion 400 of the access feature 114 than the bottom edge 414 of the lower portion 400 of the access feature 114. In this way, the speaker 330, the acoustic duct 332, and the slot 416 may be arranged such that an audio output from the speaker 330 is generated at or near the head height of a person near the access feature and external to the enclosure 108. This can be helpful in providing notifications to a person outside the enclosure 108, in various use cases.

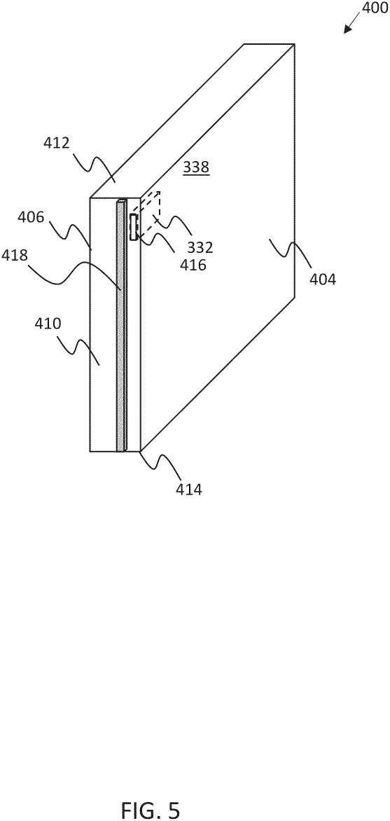

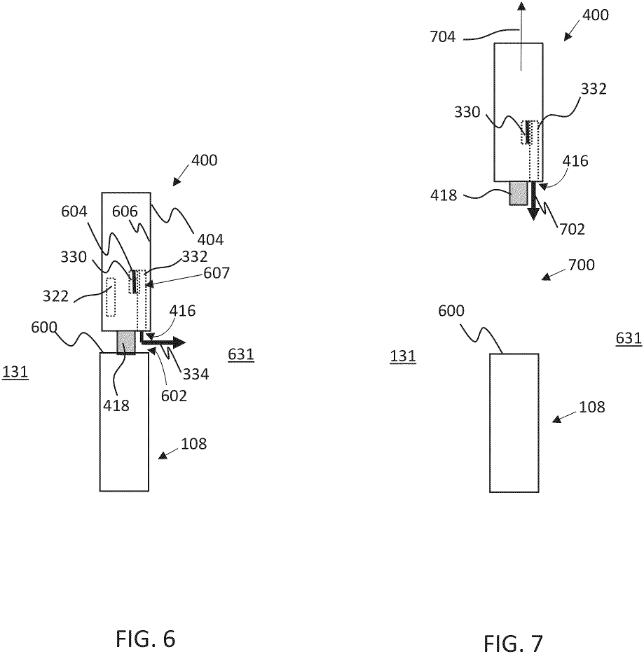

FIG. 6 illustrates a top view of a portion of the apparatus 100 in the vicinity of an interface between the access feature 114 of FIGS. 4 and 5, and the enclosure 108. In the example of FIG. 6, the access feature 114 is in a closed position.

As discussed herein, the speaker 330 may be mounted in the access feature 114 and is configured to project sound through the slot 416 in the edge 410 of the access feature 114. As shown in FIG. 6, in the closed position of the access feature 114, the structural interface 600 interfaces with a component (e.g., the sealing member 418) of the edge 410 of the access feature 114 and redirects sound from the slot 416 to a location external to the enclosure (e.g., a location in an external environment 631 of the apparatus 100). In the closed position illustrated in FIG. 6, the sealing member 418 interfaces with the structural interface 600, and may form fluid seal between the enclosed environment 131 within the enclosure 108 and the external environment 631 of the enclosure 108. Because the sealing member 418 protrudes from the edge 410 and is partially compressed between the edge 410 and the structural interface 600, the sealing member 418 may span a gap 602 between the edge 410 of the access feature 114 and the structural interface 600 of the enclosure 108. In this arrangement, the sealing member 418 and the structural interface 600 may cooperate to prevent sound from the speaker 330 from being projected into the enclosed environment 131, in part by redirecting the sound from the speaker 330 into the direction 334 to the external environment 631 (e.g., due to reflections of the sound from the surfaces of the sealing member 418 and the structural interface 600). For example, in one or more implementations, the speaker 330 may be operated (e.g., by the processor 190) to project a first notification to a location external to the enclosure 108 when the access feature 114 is in the closed position illustrated by FIG. 6.

In one or more implementations, the speaker(s) 322 mounted in the access feature 114 may also project sound into the enclosed environment 131 within the enclosure 108 when the door is in the closed position.

As shown in FIG. 6, the speaker 330 may include a sound-generating component, such as a diaphragm 604. As shown, the diaphragm 604 may be disposed opposite an internal surface 606 of the exterior wall 404, and may be separated by an air gap 607 from the internal surface 606. As shown, the acoustic duct 332 may extend from the air gap 607 between the diaphragm 604 and the internal surface 606, laterally (e.g., in a direction substantially parallel to the diaphragm, such as parallel to a plane defined by an outermost rim of the diaphragm) away from the diaphragm 604, to the slot 416. In one or more implementations, some or all of the air gap 607 may be part of the acoustic duct 332.

FIG. 7 illustrates a top view of the portion of the apparatus 100 shown in FIG. 6, in an example in which the access feature 114 is in an open position. FIG. 7 illustrates how the apparatus 100 may include the enclosure 108 having an opening 700, and a structural interface 600 that, at least partially, defines the opening 700. For example, the structural interface 600 may be an edge of the opening 700, and may extend partially or completely around the opening 700. As illustrated in FIG. 7, in the open position, the slot 416 projects sound into the opening 700 in the enclosure 108 (e.g., in a direction 702). In this configuration, the sound that is projected from the slot 416 is not redirected by the sealing member 418 or the structural interface 600 due to the separation between the slot 416 and the structural interface 600 when the access feature 114 is in the open position.

When the access feature 114 is moved to the closed position (as in FIG. 6), the access feature 114 may substantially close the opening 700 in the enclosure 108. For example, the access feature 114 may be a door that is moveable between the open position illustrated in FIG. 7 and the closed position illustrated in FIG. 6, and that includes an edge 410 and a slot 416 in the edge 410.

In the example of FIGS. 6 and 7, the access feature 114 is implemented as a sliding door (e.g., a door that opens by moving in a direction 704 substantially parallel to the exterior wall 404 of the enclosure 108). In these examples, the edge 410 may form a portion of a sidewall of the door. It is also appreciated that the access feature 114 may be implemented as another type of door, such as a side-hinged door that opens/closes by rotating about a substantially vertical axis (e.g., at a hinge mounted at a side of the door, such as a side that is opposite the edge 410), or a top-hinged or wing door that opens/closes by rotating about a substantially horizontal axis (e.g., at a hinge mounted at the top of the door). In one or more implementations in which the access feature 114 is implemented as a sliding door or as a side hinged door, the access feature may have a top and a bottom, and the slot may be disposed nearer the top of the door than the bottom of the door. In one or more implementations in which the access feature is implemented as a wing door, the edge on which the slot 416 is disposed may be a bottom edge of the door.

In an example use case, the apparatus (e.g., processor 190) may determine (e.g., using a door open/closed/locked sensor) that the access feature 114 is in the open position shown in FIG. 7, detect (e.g., using a camera 111 and/or a sensor 113) a person entering or exiting the enclosure 108 through the opening 700 while the door is in the open position shown in FIG. 7, and operate the speaker 330 to project a second notification (e.g., through the slot 416 via the acoustic duct 332) into the opening 700 in the enclosure 108 (e.g., in the direction 702) while the person is entering or exiting the enclosure 108 through the opening 700. For example, the second notification may be a verbal welcome message, such as “Welcome to the Vehicle”, a notification of a destination or a route of the vehicle, a caution notification such as “Please Watch Your Step”, a personalized notification for the person, such as, “Please proceed to seat A”, or an exit message such as a name of a current stop of the vehicle, or “Thank you for choosing this vehicle”. In this way, the apparatus 100 can use the speaker 330 to provide time-sensitive information relevant to a person exiting or entering the vehicle, to the person, while the person is entering or exiting the vehicle.

In the examples of FIGS. 6 and 7, the apparatus 100 includes a sealing member 418, on an edge 410 of the access feature 114, that fluidly seals the opening 700 when the access feature 114 is in the closed position. In these examples, the sealing member 418 helps to redirect sound from the slot 416 when the access feature 114 is in the closed position. However, it is also appreciated that, in one or more implementations, the apparatus 100 may also, or alternatively include a sealing member on the structural interface 600.

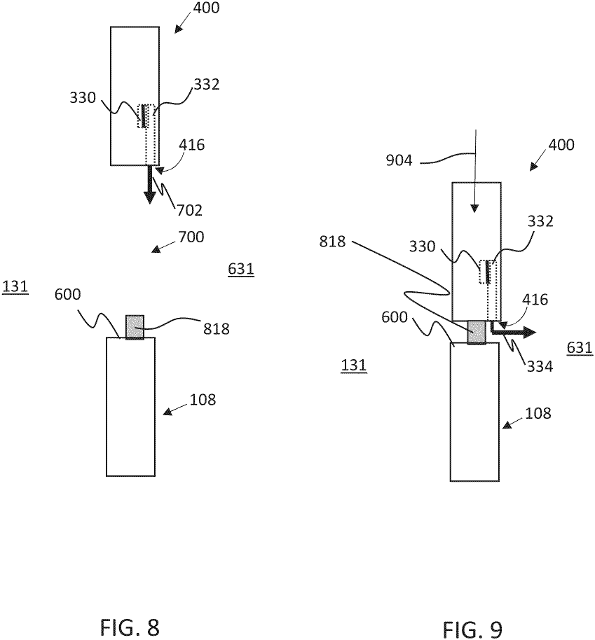

For example, FIGS. 8 and 9 illustrate an example in which the apparatus 100 includes a sealing member 818 (e.g., a rubber, silicone, and/or plastic weather seal) disposed on the structural interface 600. As illustrated in FIG. 8, in the open position of the access feature 114, the sealing member 818 does not interfere with the projection of sound from the speaker 330 into the opening 700, via the slot 416. As illustrated in FIG. 9, the access feature 114 may be moved (e.g., in a direction 904) to the closed position of the access feature 114, in which the sealing member 818 may bear against the structural interface 600 to fluidly seal the enclosed environment 131 from the external environment 631, and the structural interface 600 and the sealing member 818 may redirect the sound projected from the slot 416 outward from the apparatus 100 to the external environment 631 (e.g., in the direction 334). In the example of FIGS. 8 and 9, the apparatus 100 includes the sealing member 818 on the structural interface 600, and does not include the sealing member 418 on the edge 410. However, in one or more implementations, the apparatus 100 may include the sealing member 818 on the structural interface 600, and the sealing member 418 on the edge 410.

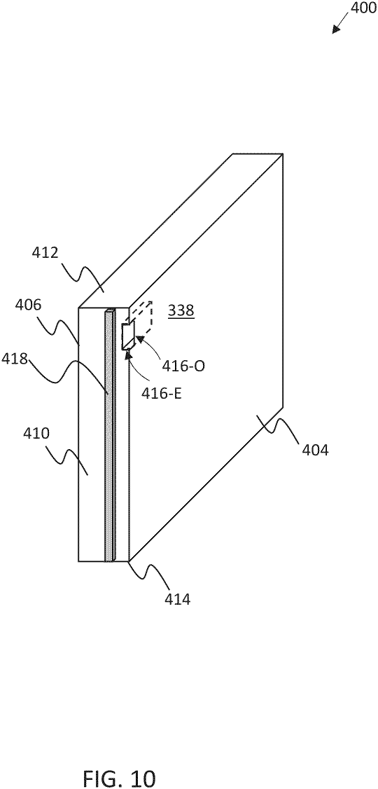

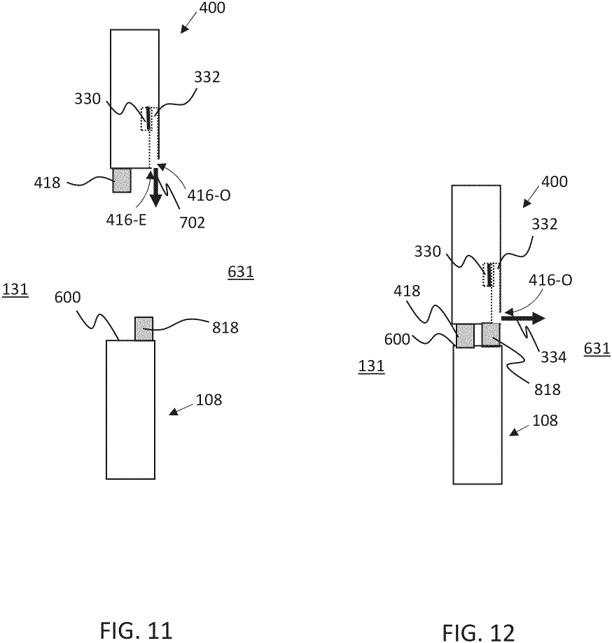

In the examples of FIGS. 4-9, the slot 416 is formed entirely in the edge 410 of the access feature 114. In one or more other implementations, the slot 416 may include multiple portions disposed in multiple respective surfaces of the access feature 114. For example, FIG. 10 illustrates an example implementation of the access feature 114 in which the slot 416 includes an edge portion 416-E formed in the edge 410 and an outer portion 416-O formed in the exterior wall 404 of the access feature 114. FIGS. 11 and 12 respectively illustrate open and closed positions of the access feature 114 of FIG. 10. In the examples of FIGS. 11 and 12, the apparatus includes the sealing member 418 on the edge 410 of the access feature 114 and the sealing member 818 on the structural interface 600. In this example, the sealing member 418 and the sealing member 818 are laterally offset so that, in the closed position, the sealing member 418 bears against the structural interface 600 and the sealing member 818 bears against the edge 410 of the access feature 114.

As shown in FIG. 11, in this configuration, in the open position of the access feature 114, sound from the speaker 330 is still substantially projected into the opening 700 from the slot 416. As shown in FIG. 12, in this configuration, in the closed position of the access feature 114, the sealing member 818 may substantially block the edge portion 416-E of the slot 416, leaving only the outer portion 416-O of the slot 416 open for egress of sound from the speaker 330 to the external environment 631 (e.g., in the direction 334).

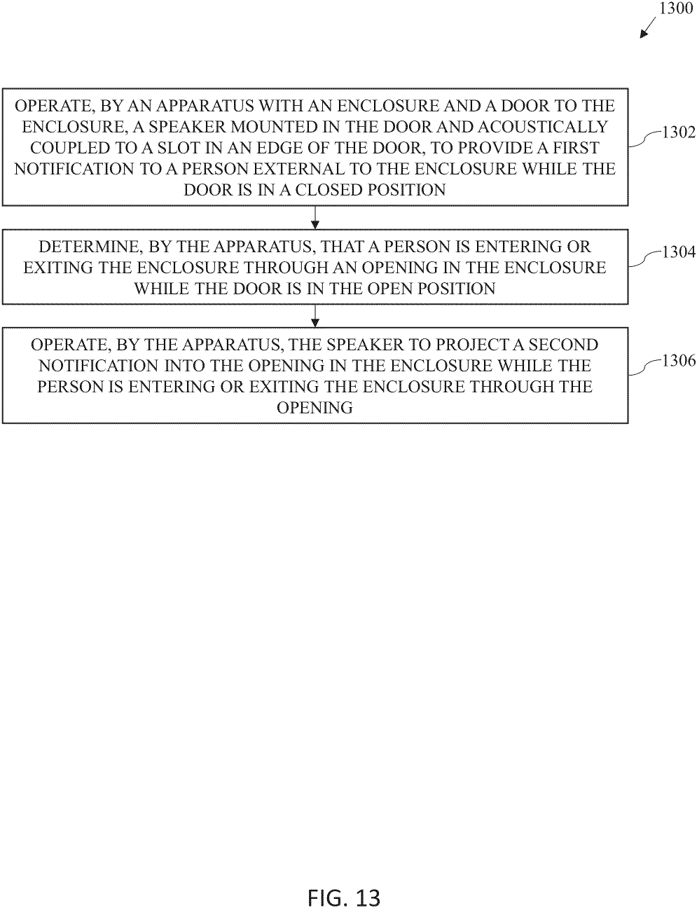

FIG. 13 illustrates a flow diagram of an example process 1300 that may be performed for operating an apparatus having an access feature with a speaker acoustically coupled to a slot in an edge of the access feature, in accordance with implementations of the subject technology. For explanatory purposes, the process 1300 is primarily described herein with reference to the apparatus 100 of FIGS. 1 and 2. However, the process 1300 is not limited to the apparatus 100 of FIGS. 1 and 2, and one or more blocks (or operations) of the process 1300 may be performed by one or more other components of other suitable devices or systems. Further for explanatory purposes, some of the blocks of the process 1300 are described herein as occurring in serial, or linearly. However, multiple blocks of the process 1300 may occur in parallel. In addition, the blocks of the process 1300 need not be performed in the order shown and/or one or more blocks of the process 1300 need not be performed and/or can be replaced by other operations.

As illustrated in FIG. 13, at block 1302, an apparatus (e.g., apparatus 100), with an enclosure (e.g., enclosure 108) and a door (e.g., access feature 114) to the enclosure, may operate a speaker (e.g., speaker 330) mounted in the door and acoustically coupled to a slot (e.g., slot 416) in an edge (e.g., edge 410) of the door, to provide a first notification to a first person external to the enclosure (e.g., in the external environment 631) while the door is in a closed position (e.g., as described herein in connection with FIGS. 3, 6, 9, and/or 12). In one or more implementations, while the door is in the closed position, operating the speaker causes an audio output from the speaker to be projected into a gap (e.g., a gap 602) between the door and a structural interface (e.g., structural interface 600) of the enclosure, and redirected in part by a sealing member (e.g., sealing member 418 and/or sealing member 818) that interfaces with the structural interface of the enclosure, to the first person external to the enclosure.

At block 1304, the apparatus may determine (e.g., using camera(s) 111 and/or sensors 113) that a second person is entering or exiting the enclosure through an opening (e.g., opening 700) in the enclosure while the door is in an open position. In various use cases, the second person may be the same as the first person, or may be different from the first person. As examples, detecting the person may include capturing an image of the opening and determining that a person is within the opening, determining that a gating sensor that projects a signal across the opening to a sensor has been blocked by an object in the opening, receiving a scan of a mobile device or a ticket by a person at, near, or within the opening, or any other operation for detecting a person or object in the opening using one or more sensors and/or one or more cameras. In one or more implementations, cameras and/or sensors for determining that a person is entering or exiting the enclosure may be activated when the access feature is moved from the closed position (e.g., as illustrated in FIGS. 3, 6, 9, and/or 12) to the open position (e.g., as illustrated in FIGS. 7, 8, and/or 11).

At block 1306, the apparatus may operate the speaker to project (e.g., in a direction 702) a second notification into the opening in the enclosure while the second person is entering or exiting the enclosure through the opening (e.g., as described herein in connection with FIGS. 7, 8, and/or 11). For example, the second notification may be a time-sensitive notification corresponding to exiting or entering the apparatus. Examples of time-sensitive notifications corresponding to exiting or entering the apparatus may include a welcome message to a person entering the apparatus, a goodbye or thank-you message to a person exiting the apparatus, a seat assignment or a destination announcement for a person entering the apparatus, a name of a current stop of the apparatus for a person exiting the apparatus, or any other notification relevant to a general person or a specific person entering and/or exiting the apparatus.

In one or more implementations, the apparatus may be implemented as a vehicle, and the process 1300 may also include operating, by the vehicle, an additional speaker mounted in the door (e.g., a speaker of the speaker(s) 322) to project an additional audio output to an enclosed environment (e.g., enclosed environment 131) within the enclosure.

Various processes defined herein consider the option of obtaining and utilizing a user’s personal information. For example, such personal information may be utilized in order to provide notifications using a door mounted external speaker. However, to the extent such personal information is collected, such information should be obtained with the user’s informed consent. As described herein, the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well-established, user-accessible, and recognized as in compliance with or above governmental/industry standards. Moreover, these parties will not distribute, sell, or otherwise share such information outside of any reasonable and legitimate purposes.

Users may, however, limit the degree to which such parties may access or otherwise obtain personal information. For instance, settings or other preferences may be adjusted such that users can decide whether their personal information can be accessed by various entities. Furthermore, while some features defined herein are described in the context of using personal information, various aspects of these features can be implemented without the need to use such information. As an example, if user preferences, account names, and/or location history are gathered, this information can be obscured or otherwise generalized such that the information does not identify the respective user.

In accordance with aspects of the subject disclosure, an apparatus is provided that includes an enclosure having an opening and a structural interface that defines the opening; a door that is moveable between an open position and a closed position and that includes an edge and a slot in the edge; a speaker mounted in the door and configured to project sound through the slot in the edge of the door. In the closed position, the structural interface interfaces with a component of the edge of the door and is configured to redirect sound from the slot to a location external to the enclosure, and, in the open position, the slot is configured to project sound into the opening in the enclosure.

In accordance with aspects of the subject disclosure, a method is provided that includes operating, by an apparatus with an enclosure and a door to the enclosure, a speaker mounted in the door and acoustically coupled to a slot in an edge of the door, to provide a first notification to a first person external to the enclosure while the door is in a closed position; determining, by the apparatus, that a second person is entering or exiting the enclosure through an opening in the enclosure while the door is in an open position; and operating, by the apparatus, the speaker to project a second notification into the opening in the enclosure while the second person is entering or exiting the enclosure through the opening.

In accordance with aspects of the subject disclosure, a door for an apparatus is provided, the door including an exterior wall; an interior wall; an interior cavity defined in part by the exterior wall and the interior wall; an edge extending substantially between the exterior wall and the interior wall and further defining a portion of the interior cavity; a speaker disposed within the interior cavity; a slot in the edge; an acoustic duct extending from the speaker to the slot; and a sealing member that runs along the edge substantially parallel to the interior wall and the exterior wall, a portion of the sealing member disposed on the edge between the slot and the interior wall.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neutral gender (e.g., her and its) and vice versa. Headings and subheadings, if any, are used for convenience only and do not limit the subject disclosure.

What is claimed is:

1. An apparatus, comprising;
an enclosure having an opening and a structural interface that defines the opening;
a door that is moveable between an open position and a closed position and that includes an edge and a slot in the edge; and
a speaker mounted in the door and configured to project sound through the slot in the edge of the door, wherein:
in the closed position, the structural interface interfaces with a component of the edge of the door and is configured to redirect sound from the slot to a location external to the enclosure, and
in the open position, the slot is configured to project sound into the opening in the enclosure.

2. The apparatus of claim 1, wherein the component of the edge of the door comprises a sealing member on the edge of the door.

3. The apparatus of claim 2, wherein, in the closed position of the door, the sealing member interfaces with the structural interface to form fluid seal between an enclosed environment within the enclosure and an external environment of the enclosure.

4. The apparatus of claim 1, wherein the door comprises a sliding door, and wherein the edge comprises a sidewall of the door.

5. The apparatus of claim 4, the door comprises a top and a bottom, and wherein the slot is disposed nearer the top of the door than the bottom of the door.

6. The apparatus of claim 1, wherein the door comprises a wing door, and wherein the edge comprises a bottom edge of the door.

7. The apparatus of claim 1, further comprising at least one additional speaker mounted in the door and configured to project sound into an enclosed environment within the enclosure when the door is in the closed position.

8. The apparatus of claim 1, further comprising a computing component configured to operate the speaker to project a first notification to the location external to the enclosure when the door is in the closed position.

9. The apparatus of claim 8, wherein the computing component is further configured to:
determine that the door is in the open position;
detect a person entering or exiting the enclosure through the opening while the door is in the open position; and
operate the speaker to project a second notification into the opening in the enclosure while the person is entering or exiting the enclosure through the opening.

10. A door for an apparatus, the door comprising:
an exterior wall;
an interior wall;
an interior cavity defined in part by the exterior wall and the interior wall;
an edge extending substantially between the exterior wall and the interior wall and further defining a portion of the interior cavity;
a speaker disposed within the interior cavity;
a slot in the edge;
an acoustic duct extending from the speaker to the slot; and
a sealing member that runs along the edge substantially parallel to the interior wall and the exterior wall, wherein a portion of the sealing member is disposed on the edge between the slot and the interior wall.

11. The door of claim 10, wherein the speaker comprises a diaphragm disposed opposite an internal surface of the exterior wall and separated by an air gap from the internal surface.

12. The door of claim 11, wherein the acoustic duct extends from the air gap, laterally away from the diaphragm, to the slot.

13. The door of claim 10, wherein the exterior wall, the interior wall, the edge, and the interior cavity form a lower portion of the door having a top edge and a bottom edge, and wherein the door further comprises a window that is retractable into the interior cavity in an open configuration of the window, and extendible from the top edge of the lower portion of the door to form at least a part of an upper portion of the door in a closed configuration for the window.

14. The door of claim 13, wherein the slot is located nearer the top edge of the lower portion of the door than the bottom edge of the lower portion of the door.

15. The door of claim 10, wherein the slot comprises an edge portion formed in the edge and an outer portion formed in the exterior wall.

16. The door of claim 10, wherein the apparatus comprises a vehicle, and wherein the sealing member is configured to interface with an edge of an opening in an enclosure of the vehicle.

17. A method, comprising:
operating, by an apparatus with an enclosure and a door to the enclosure, a speaker mounted in the door and acoustically coupled to a slot in an edge of the door, to provide a first notification to a first person external to the enclosure while the door is in a closed position;
determining, by the apparatus, that a second person is entering or exiting the enclosure through an opening in the enclosure while the door is in an open position; and
operating, by the apparatus, the speaker to project a second notification into the opening in the enclosure while the second person is entering or exiting the enclosure through the opening.

18. The method of claim 17, wherein the second notification is a time-sensitive notification corresponding to exiting or entering the apparatus.

19. The method of claim 17, wherein, while the door is in the closed position, operating the speaker causes an audio output from the speaker to be projected into a gap between the door and a structural interface of the enclosure, and redirected in part by a sealing member that interfaces with the structural interface of the enclosure, to the first person external to the enclosure.

20. The method of claim 19, wherein the apparatus further comprises a vehicle, the method further comprising operating, by the vehicle, an additional speaker mounted in the door to project an additional audio output to an enclosed environment within the enclosure.
